(19) United States
(12) Patent Application Publication
(10) Pub. No.: US 2014/0122327 A1
(43) Pub. Date: May 1, 2014

(54) CROSS BORDER GIFT CARDS

(71) Applicant: Quippi Corporation, La Jolla, CA (US)

(72) Inventors: Michael Aleles, San Marcos, CA (US); Brett Gottlieb, Carlsbad, CA (US); Ian Barile, Palo Alto, CA (US)

(73) Assignee: Quippi Corporation, La Jolla, CA (US)

(21) Appl. No.: 14/067,869

(22) Filed: Oct. 30, 2013

Related U.S. Application Data
(60) Provisional application No. 61/721,005, filed on Oct. 31, 2012.

(51) Int. Cl. G06Q 20/34

(52) U.S. Cl. CPC G06Q 20/342
USPC 705/39

(57) ABSTRACT

International transactions from a first country to a second country can be facilitated using a gift card purchased by a purchaser in the first country from a seller entity, conveyance of a code or other redemption information to a recipient in the second country, and redemption of the code or other redemption information at a redeeming entity. Methods, systems, article of manufacture and the like are described.

### CROSS-REFERENCE TO RELATED APPLICATIONS

The current application claims priority under 35 U.S.C. §119(e) to U.S. provisional application No. 61/721,005 filed on Oct. 31, 2012, the disclosure of which is incorporated herein by reference.

### TECHNICAL FIELD

The subject matter described herein relates to approaches for conveying monetary value or other purchasing ability or resources between a sender in a first country and a receiver in a second country and more particularly to completing such a transaction using a cross-border gift card (electronic or physical) purchased in the first country and redeemed from a vendor in the second country.

### BACKGROUND

According to the United Nations, more than 215 million people live outside their countries of birth. An important effect of this trend of international migration is an overall boosting of world incomes. Workers are able to move to where they are more productive and capable of receiving higher wages, thereby resulting in an increase in aggregate output and income. In many instances, a worker who has migrated from one country (hereinafter referred to as a “second country”) to another country (hereinafter referred to as a “first country”) in search of higher wages or otherwise greater compensation or a better economic situation than is available to him or her in the second country will maintain ties with family, friends, or other dependents or associates in the second country. These ties can often include financial ties, as a worker enjoying elevated compensation in the first country will generally seek to send financial support to people in the second country.

Such flows of funds are generally referred to as international remittances or international remittance flows, and were estimated to total $483 billion (U.S.) in 2011 of which approximately $351 billion included international remittances to developing countries. International remittances sent home by migrants to developing countries are estimated by the World Bank to be three times the size of official development assistance provided to such countries.

Conventionally, such international remittances are made by international bank wire, traditional cash-based money transfer services, by mailing of cash or cash equivalents (e.g. cashier's check, money order, etc.), and the like. Such approaches suffer from challenges such as high fees to either or both of the sending and receiving parties, lack of security of the transfer, or the like. Offering a low cost alternative to remittance transfers produces significant benefits not only to the migrants and the recipients of economic value, but also to receiving countries, as the steady stream of foreign currency can provide a boost to the local economy, can improve a country's apparent creditworthiness for external borrowing, or the like.

### SUMMARY

Implementations of the current subject matter can improve one or more deficiencies in the prior art, for example by facilitating international transactions from a first country to a second country using a gift card purchased by a purchaser in the first country from a seller entity. The purchaser (or some other person or entity) can transmit redemption information (e.g. a redemption code) to a recipient in the second country, who can redeem the value of the gift card at a redeeming entity in the second country. The value of the gift card can optionally be redeemed for one or more of goods, services, a credit that is usable at a later time for goods and/or services at the redeeming entity or an affiliate of the redeeming entity, and the like. Advantageously, the value redeemed by the recipient can be approximately equivalent to a value of the gift card purchased by the sender form the selling entity. However, the scope of the current subject matter may also include implementations in which a currency conversion fee, other handling fee, or the like can be deducted from the value redeemed by the recipient.

In one aspect, a method includes an international gift card service validating a gift card in response to a first notification received at the international gift card service from a selling entity doing business in a first country. The notification can relate to an international gift card purchase transaction that includes a transfer of value from a purchaser to the selling entity in exchange for a gift card credit amount. The method further includes the international gift card service at least some of the value transferred to the selling entity by the purchaser from the selling entity, and processing a redemption transaction occurring at a redeeming entity in a second country. The redemption transaction can include an exchange of a redemption value for one or more goods and services provided by the redeeming entity. The redemption value can include at least some of the gift card credit amount. The international gift card service compensates the redeeming entity with at least a part of the redemption value.

In optional variations, one or more of the following additional features can be included in any feasible combination. The transfer of value can include at least one of a cash payment, a cash equivalent payment, a credit card purchase transaction, and an exchange of an item of value between the purchaser and the selling entity. The international gift card purchase transaction can include at least one of a purchase of a new gift card and an add value transaction using a previously purchased gift card. The international gift card purchase transaction can occur via at least one of a first physical retail location, a first dedicated public kiosk, and a first online transaction, and the redemption transaction can occur via at least one of a second physical retail location, a second dedicated public kiosk, and a second online transaction. The processing can include determining that a redemption code provided to the recipient by the purchaser and redeemed at the redeeming entity is correct and valid and that the gift card currently includes a sufficient value to cover the redemption value. The compensating can include the international gift card service compensating the redeeming entity with the redemption value less at least one a currency conversion fee, a transaction fee retained by the international gift card service. The international gift card purchase transaction transfer of value can include a first currency of the first country and the redemption value of the redemption transaction can include a second currency of the second country.

Implementations of the current subject matter can include, but are not limited to, methods consistent with the descriptions provided herein as well as articles that comprise a tangibly embodied machine-readable medium operable to cause one or more machines (e.g. computers, etc.) to perform operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating features of an international transaction consistent with one or more implementations of the current subject matter;

FIG. 2 shows a diagram illustrating aspects of a system architecture showing features consistent with implementations of the current subject matter; and

FIG. 3 shows a communications diagram illustrating a redemption transaction process for a gift card that can be used without a networked point of sale terminal consistent with implementations of the current subject matter;

FIG. 4A, FIG. 4B, FIG. 4C, and FIG. 4D show a series of screen shots of a mobile application that can be used for redemption transactions for gift cards consistent with implementations of the current subject matter; and

FIG. 5 shows a process flow chart illustrating features of a method consistent with implementations of the current subject matter.

When practical, similar reference numbers denote similar structures, features, or elements.

### DETAILED DESCRIPTION

Features of the current subject matter, whether taken individually or in one or more combinations consistent with the descriptions and examples provided herein, can streamline and reduce the costs associated with international transactions both to a recipient in a second country as well as a sender in a first country. In some aspects, the sender can purchase a gift card through a purchase interaction with a seller entity (e.g. a first retailer) in the first country. The gift card can include, without limitation, one or more identifying codes and redemption codes. By conveying the redemption code to a recipient in a second country, the recipient can redeem the full value of the gift card, optionally in a local currency appropriate for transactions in the second country. The redeeming of the gift card by the recipient can occur at a redeeming entity (e.g. a second retailer) in the second country. An international transaction performed in this manner can involve no service fees assessed to either of the sender or the recipient. Rather, either or both of the seller entity and an international gift card service that provides the framework for the international transaction can receive some fraction of the total value of the international transaction as a service fee that is deducted from the amount ultimately paid to the redeeming entity upon redemption by the recipient of the gift card at the redeeming entity. The redeeming entity nonetheless receives a benefit from the transaction in that the gift card purchased by the sender is tied to a specific redeeming entity (e.g. a chain or retailers, a specific retailer, etc.). In this manner, although the redeeming entity surrenders some percentage of its profit margin of the ultimate value of goods, services, etc. purchased by the recipient in redeeming the gift card, the sales of these goods, services, etc. is captured at the time that the sender purchases the gift card. The redeeming entity is also able to generate traffic from new customers.

Other information, such as for example a value associated with the gift card, an allowed method of redemption, or the like, can also be associated with the gift card, e.g. using any of printing, encoding, etc. The one or more identifying codes and redemption codes can optionally be printed directly on the gift card; encoded via a magnetic strip or a barcode, radio frequency identification (RFID) device, or other machine-readable feature; printed on the gift card but obscured or hidden under a security feature (including but not limited to a “scratch off” covering designed to be removed after purchase or activation of the gift card); or the like. Different approaches or mechanisms can be used to include the one or more identifying codes and redemption codes associated with a gift card.

As used herein and unless otherwise specified explicitly or as used in context, the term gift card broadly includes a restricted monetary equivalent, scrip, PIN code, or the like that includes an assigned value or other purchasing ability that can be exchanged for goods or services according to one or more restrictions. Examples of gift cards can include information printed or otherwise displayed upon paper or other media, a physical card that is optionally similar in size and shape to a credit card or automated teller machine card and that that includes information stored or encoded by one of a variety of methods, virtual gift cards, and the like.

As noted above, a physical gift card may have one or more identification codes stored upon or within it using one or more approaches. For example, an identification code can be stored using an optically readable encoding approach, such as for example a bar code, a quick response (QR) code, or the like that can be read by an optical reader device. Alternatively or in addition, a code can be stored using a machine-readable or computer-readable medium, such as for example a magnetic strip; a “smart card” chip, a radio frequency identification (RFID) chip, or the like. Any optical, electronic, magnetic, or other devices or techniques for storing an identification code are also within the scope of the current subject matter. The identification code identifies a gift card and is desirably unique to the specific gift card having that identification code.

A gift card as used herein can also include virtual gift cards or mobile gift cards, which can be conveyed to a purchaser or recipient via one or more electronic channels, such as for example e-mail, a SMS message, an automated voice recording, a smart phone application (e.g. phones using an operating system such as iOS, Android, Blackberry, Windows Mobile, or the like) allowing users to carry only their cell phones or, alternatively, to receive a redemption code that can be given to a recipient in person, by phone, by fax, by e-mail, by text message, by voice (e.g. in person or over a phone or other electronic connection) or the like. For a virtual gift card, for example a gift card purchased over the Internet, using a networked mobile device, a networked kiosk, or the like, the identification code can be provided electronically in one or more formats, such as for example a string of characters, a bar code or QR code, etc. It is also within the scope of one or more implementations of the current subject matter to allow a gift card purchaser to use an interactive voice response (IVR) system or the like to make a gift card purchase.

Unlike a physical gift card, a virtual gift card typically includes one or more identification codes that need not be printed on or encoded in a physical article. The identification code or other data, etc. that uniquely identifies a gift card having that identification code can be provided electronically, audibly, or by other approaches to a gift card purchaser. An identification code provided include information displayed via a screen of a computer or computing device (e.g. a desktop or laptop computer, a smart phone, a cell phone, a tablet computer, etc.), for example as part of a web page displayed on the screen, transmitted and received in a message (e.g. e-mail, SMS, MMS, text, etc.) sent to a computer or computing device over a communication network, printed onto a physical medium (e.g. a cash register receipt, a piece of paper, a card, etc.), or the like. The purchaser of a virtual gift card can transmit the identification code or other data necessary to redeem the value associated with the virtual gift card to a recipient.

A gift card can also include a redemption code, which can in some examples be referred to as a personal identification number code (e.g. a “PIN code”). The redemption code can be a combination of one or more of numbers, letters, or other characters in a particular order that is unique to the specific gift card. This redemption code can be used to redeem some or all of the value associated with the gift card. In some examples, the identification code can include the redemption code. Additional description of examples of the redemption process that are consistent with implementations of the current subject matter is provided below.

In some implementations of the current subject matter, a gift card may have no value until the time of sale, at which time a cashier or other authorized user at a point of sale enters the amount that a customer wishes to put on the card. This amount of value usable by redeeming the card is typically not stored on the card (assuming the gift card is a physical gift card) but is instead recorded in a database, with cross-referencing to the card identification code and also to the redemption code if a redemption code is used. To thwart or otherwise hinder or limit counterfeiting, such data can advantageously be encrypted when stored on a physical gift card. For both physical gift cards and virtual gift cards, other anti-fraud or other types of security measures can also be used, for example as discussed below. Other gift cards may have a set value and need to be activated by calling a specific number or by transmitting a transaction completion message to one or more central servers that maintain control over or otherwise administer activation and redemption of purchased gift cards.

In general, gift cards can be classified as “open loop” (also referred to as “network”) cards or “closed loop” cards. Open loop gift cards are typically issued by banks or credit card companies and are redeemable by different establishments. Closed loop gift cards are typically issued by a specific provider (e.g. a store or chain of stores, restaurant or chain of restaurants, or the like) and can be only redeemed by the issuing provider. In either example, a purchaser would buy the gift card, and the recipient of the card would use the value of the card at a later transaction. A third form can be considered as a hybrid of the open loop and closed loop approaches in which a gift card can be purchased for use at a more than one distinct retailer. As an example, a group of retailers that are unrelated except for physical proximity (e.g. stores in a specific shopping mall or other cluster of stores, etc.), similarity of merchandise (e.g. grocery stores, clothing stores, shoes stores, or the like)

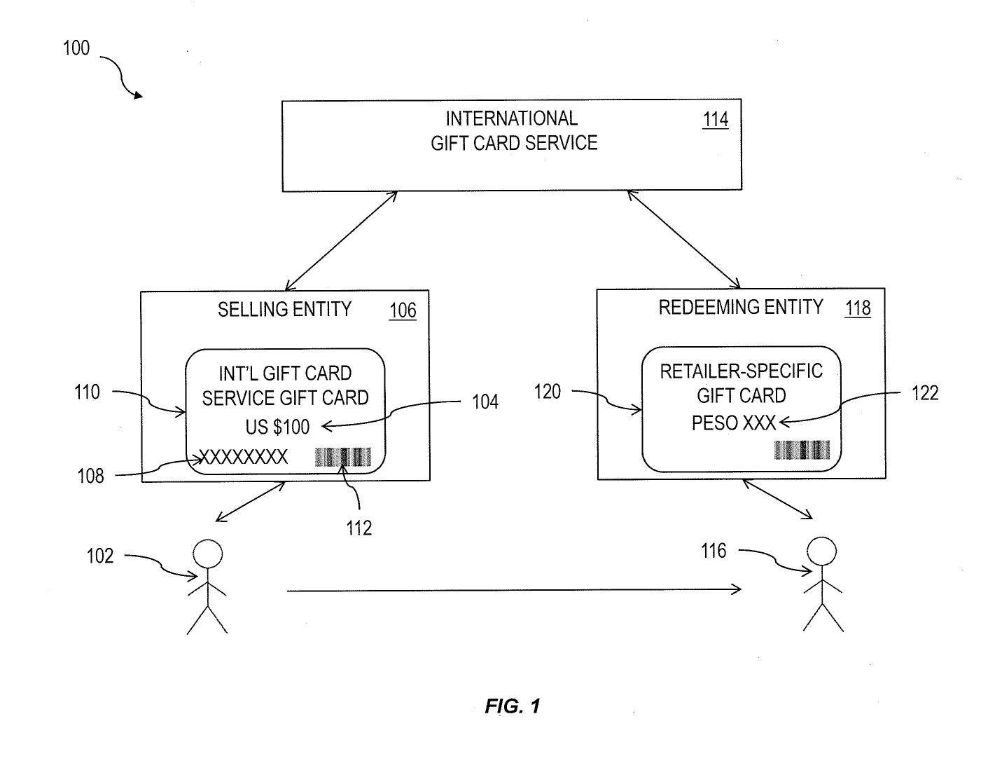

As illustrated in the diagram 100 of FIG. 1, a purchaser 102 (also referred to as a “sender”) purchases an amount of credit 104 at a seller entity (e.g. a first retailer) 106, which can include a physical store location, an online portal, a kiosk, a mobile application, or the like. The amount of credit 104 provided to the purchaser 102 can be equivalent to the amount of payment made by the purchaser 102 to the first retailer 106 (e.g., as shown in FIG. 1, if the purchaser 102 provides payment in any form of US $100 the amount of credit 104 is also US $100).

The purchaser 102 receives a code 108 representative of the amount. This code 108 can take one or more of many forms, and can optionally include a coding of a card identification as well as a redemption code and other information necessary to ensure a secure transaction. For example, as shown in FIG. 1, the code 108 can be imprinted upon a physical gift card 110, which can take any of the forms discussed above or their functional equivalents. Alternatively or in addition, the code 108 can be included within a virtual gift card, and can thereby be provided to the purchaser 102 via one or more electronic means or approaches, such as for example by display on a computer or mobile device screen in a web page (e.g. in a browser window), as a downloadable document (e.g. as a PDF file or the like that can be downloaded to a computer or mobile computing device or converted to a physical form by printing or other techniques), in an e-mail message, in a text message (e.g. as a short messaging system or SMS message), in a multimedia message (e.g. as a multimedia messaging system or MMS message), as an audible code conveyed by a human operator or a cashier/clerk, as a machine generated audible code conveyed via an interactive voice response (IVR) system either over a telephone connection or in person (e.g. at a sales kiosk, via a telephony or VoIP connection facilitated by a computing device, printed on a receipt or other physical medium, etc.), as an alphanumeric code (e.g. all letter, all numbers, or a combination of letters and numbers and optionally other characters provided over a voice connection such as a voice mail, a direct call from a human or machine operator, a printed representation of the code, etc.). A physical gift card 110, such as for example that shown in FIG. 1, can include a bar code 112 or other encoding functionality that can be read by a device, such as for example a bar code reader. Other types of encoding functionality, such as for example a quick response (QR) code, a magnetic strip, an RFID chip, or the like, are also within the scope of the current subject matter. The bar code can optionally include the redemption code 108, other information, etc.

The amount of credit 104, optionally less a first margin, is transferred from the selling entity 106 to an international gift card service 114. The international gift card service 114, which is discussed in greater detail below, generally includes one or more software routines executing on one or more systems, which can each include one or more programmable processors.

The purchaser 102 (or some other person who obtains the code 108 from the purchaser 102) can communicate the code 108 to a recipient 116, who is generally in a second country. The recipient 116 can redeem the code 108 at a redeeming entity (e.g. a second retailer) 118, which is typically located in the second country, to receive a credit equivalent to the amount of credit 104. The redeeming entity 118 can be a member or other participating or cooperating entity with the international gift card service 114. Once the recipient 116 has redeemed the code 108 to receive the amount of credit 104, the recipient 116 can optionally apply the entire amount of credit 104 toward purchases made at the redeeming entity 118 or, optionally, retain some or all of the amount of credit 104 in the form of a second gift card 120 that can be saved for use at a later date. If the second country uses a different currency than the first country, the amount of credit 108 can be denominated as an equivalent amount 122 in the different currency, or can optionally include an at least nominal deduction to reflect currency conversion transaction fees. The second gift card 120 can, in some implementations of the current subject matter, be specific to the redeeming entity (i.e. the some or all of the amount of credit not used at the time that the recipient 116 redeems the code 108 at the redeeming entity 118 can be made available for use only at one or more locations or optionally online portals of the redeeming entity 118 or affiliates of the redeeming entity 118). The redeeming entity 118 can, in various implementations of the current subject matter, be a single store, an online retailer doing business in the second country, a chain of retail stores, a restaurant, a chain of restaurants, a group or stores or restaurants or the like, a localized group of retail establishments or the like, etc. The redeeming entity 118 can also optionally have an online presence and can be capable of shipping goods to the recipient 116 or to a second recipient or shipping address designated by the recipient 116.

The second gift card 120 can be a physical gift card as in FIG. 1. Alternatively, the unused value on the second gift card can be retained as a virtual gift card available for use in the second country, for example during a second visit to the redeeming entity 118 or to another redeeming entity that also honors or otherwise provides redemption of the gift card.

While some aspects of the example illustrated in FIG. 1 are explained in reference to a physical gift card 110, other approaches to completing gift card transactions consistent with the current subject matter are also within the scope of this disclosure. For example, as noted above, the gift card need not be a physical gift card 110, and the second gift card 120 can likewise be a virtual gift card. Rather, if the gift card purchasing transaction occurs at a point of sale, the purchaser 102 can obtain the code 108 through any feasible method of conveying a code. For example, the code 108 can be conveyed to the purchaser 102 verbally (either via a machine with speech capabilities or by a human cashier or clerk or the like), as a printout on a receipt (or other printable medium such as paper, plastic, etc.) or display device (e.g. a computer or mobile device screen, a series of alphanumeric or numeric indicators on a machine, etc.), as an electronic message sent to a device operable by or in possession of the purchaser 102 (e.g. as an e-mail message, an MMS or SMS message, a link to a web page, etc. sent to a cellular phone, a smart phone, a computer, an e-mail address, etc.). Once in possession of the code 108, the purchaser 102 (or some other person or intermediary who receives the code 108 from the purchaser) can convey the code 108 to the recipient as outlined above in reference to FIG. 1.

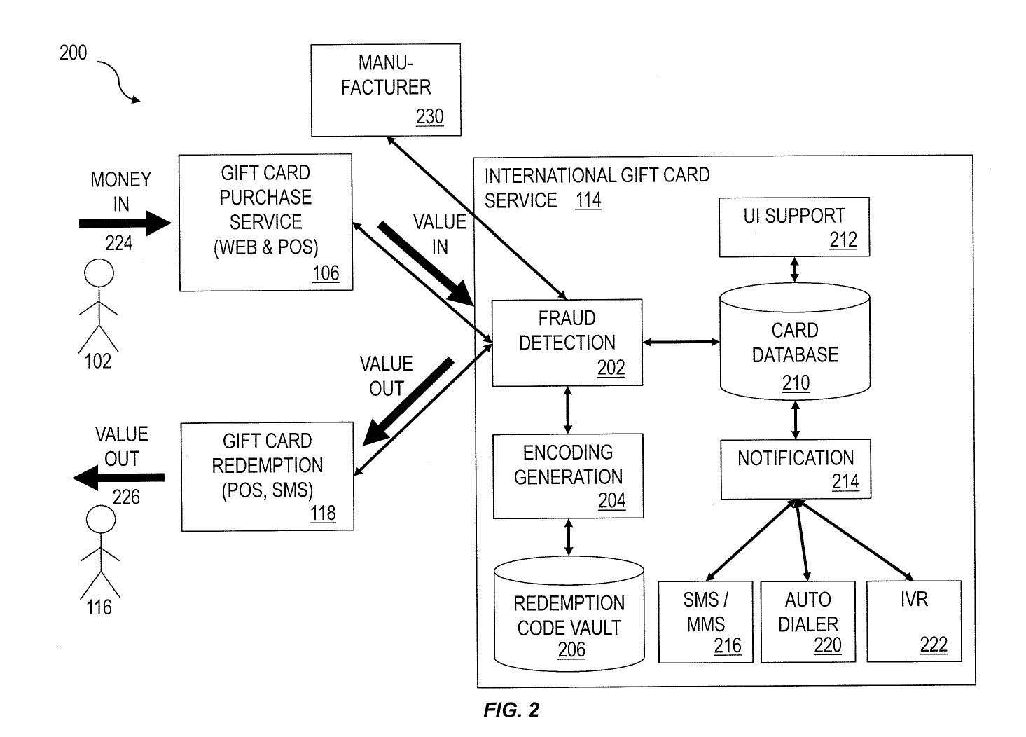

As shown in FIG. 2, a system architecture 200 for performing an international transaction consistent with implementations of the current subject matter can include an international gift card service 114. The international gift card service 114 can include or otherwise be implemented on at least one and optionally more than one processor, memory device, and network connection. In some implementations of the current subject matter, all functionality of an international gift card service 114 can be provided from a single, standalone system that can include one or more processors and memory devices. The configuration of the system architecture 200 shown in FIG. 2 is representative of such an arrangement. However, it will be well understood that one or more functions, modules, agents, etc. that support operation of an international gift card service 114 consistent with implementations of the current subject matter can be provided by separate computing systems, such as for example through use of distributed (e.g. cloud) computing approaches.

As shown in FIG. 2, an international gift card service 114 can optionally include one or more of a fraud detection module 202, an encoding generation module 204, a PIN or redemption code vault 206, a card database 210, a user interface (UI) support layer or module 212, a notification module 214, and one or more notification subsystems, such as for example one or more of a SMS/MMS-based communication subsystem 216, an automated dialer subsystem 220, and an IVR subsystem 222. The fraud detection module 202 can handle validations necessary to identify and deter potentially fraudulent transactions as discussed in greater detail below.

Similarly to the transaction flow discussed above in relation to the example of FIG. 1, a transaction can include an inflow of value or other purchasing ability (referred to herein generally as “value”) 224, for example from a purchaser 102 of a gift card to a selling entity 106 of a gift card 110 in a first country. The purchaser 102 can purchase a gift card from the selling entity 106, which can include without limitation a gift card purchase service, such as for example an online portal, a physical point of sale, or the like. Alternatively, the inflow of value 224 can be a “re-loading” of a previously purchased gift card to add additional value to the gift card. The transaction can be processed by the fraud detection module 202 upon redemption of the gift card by a recipient 106 in a second country who receives a value 226 (e.g., goods, services, a second gift card, or some combination thereof) from the redeeming entity 118. The redeeming entity 118 can include without limitation a gift card redemption service such as for example an online portal, a physical point of sale, or the like. As noted above, the transaction between the purchaser 102 and the recipient 106 can in at least some implementations of the current subject matter be effectively fee-free from the perspectives of either of the purchaser 102 or the recipient 116 except optionally for a currency conversion transaction fee. The costs of the transaction can in some examples be borne predominantly by the redeeming entity 118, while at least one of the international gift card service 114 and the selling entity 106 can receive some fraction of the inflow of value 224 from the purchaser 102. The recipient 116, as noted above, can receive a value 226 in goods, services, later-redeemable gift card value, etc., or combinations thereof that is at least approximately equivalent to the inflow of money provided by the purchaser 102 to the selling entity 106.

An encoding generation module 204 executing on the same computing system as the fraud detection module 202 or otherwise in communication with the fraud detection module 202 can handle generation of one or more of identification codes 112, redemption codes 108, account numbers, and the like. Such generation can be performed using a random algorithm or other similar functionality. For example, numbers, which can optionally be sequential or non-sequential, can be generated and stored in a database or database table. These numbers can be encoded, for example using a hash algorithm, a randomization algorithm, a security algorithm (e.g. an encryption algorithm etc.), or the like. A request for an encoded number to the encoding generation module 204 can prompt the necessary operations and a result returned as a message in text format, binary format, some other encoded format, or the like.

A gift card creation service operating within the fraud detection module 202 or otherwise in communication with the fraud detection module 202 can receive a number of cards to be generated as part of a manufacturing process and can return a value (e.g. a Boolean value) and a message in a text or other messaging format with the result. The gift card creation service can optionally use a random algorithm in order to match identification codes 112 and redemption codes 108 for a specific gift card. Inputs can include a lot identifier (e.g. a lot number or the like), an amount a value left on a card, and an amount of an intended transaction.

A gift card allocation service operating within the fraud detection module 202 or otherwise in communication with the fraud detection module 202 can receive a lot, grouping, set, etc. of gift cards to be printed and can receive from a manufacturer 230 an indication of success or failure in generating (e.g. manufacturing, printing, encoding, etc. of a gift card or lot of gift cards). Upon receipt by the gift card allocation service of the indication of success or failure, the gift card allocation service can set the state of the gift cards according to the indication of success or failure. The gift card allocation service can also handle tasks such as assignment of virtual gift cards, such as for example those sold via a website, over a telephonic interface (e.g. interaction of a purchaser 102 with a human operator or an IVR system), via an app on a mobile device, at a point of sale or kiosk that provides a code 108 that is either displayed or provided to the purchaser 102 using an approach other than a pre-printed card, or the like. Such gift cards do not need to be printed or otherwise manufactured.

In some implementations of the current subject matter, the fraud detection module 202 can receive a query from a manufacturer 230 and can generate one or more lots of gift cards to be printed. These one or more lots are then returned to the manufacturer 230. Physical gift cards 110 can be generated by the manufacturer 230, which can be required to interface with the fraud detection module 202, to ensure that only gift cards registered in the card database 210 are printed and the all gift cards that are printed are delivered to the proper selling entities 106. As an example, a request for gift cards and the identification codes 112 and redemption codes 108 corresponding to those gift cards can be processed by a service that receives a lot and returns a list generated from the redemption code vault 206 along with identification codes 112 and redemption codes 108 ready to be printed. The fraud detection module 202, an external verification service in communication with the fraud detection module 202, or the like, can receive and process a list of printed gift cards and update the state of these gift cards in the card database 210 to “Printed.” An indication of success can be returned if the complete lot was printed. Alternatively, a report can be generated to include list of gift cards that were not printed.

Invalidation of gift cards can be processed by an invalidation service within the fraud detection module 202 or otherwise in communication with the fraud detection module 202. The invalidation service can allow a lot of gift cards to be deactivated or otherwise invalidated. Invalidation can be necessary if a shipment of gift cards is lost, if a lot or set of codes is compromised, etc.

One or more validation checks can be performed in association with the above-noted services. For example, gift cards sent to be printed can be verified to correspond to a particular batch. Gift cards that are sent to print can also be verified to have a correct state (e.g. inactive). The algorithm used to generate codes can be verified to be secure, unique, random, or the like. A matching algorithm (e.g. to process pairing of a gift card code and its corresponding pin value) can be verified to be secure and random. Gift card codes and bar codes can be validated when a manufacturer 230 or other printer service, etc. notifies the fraud detection module, an external alert service in communication with the fraud detection module 202, or the like that a particular lot has been printed. Invalidation of already used gift card codes 108 and bar codes can be performed to verify that these codes cannot be reused in future gift cards. Validation checks can also verify that invalid gift cards are not available for purchase, that a full lot of card is actually printed (e.g. to deter or prevent fraud by a printer service), and the like.

The fraud detection module can also handle one or more aspects of ensuring a secure transaction using gift virtual gift cards, including acting as a portal for transmitting of unique redemption codes 108 to the selling entity 106, receiving a transmission of a redemption code from the redeeming entity 118 when the recipient 116 redeems the redemption code 108 for value, etc.

Benefits of implementations of the current subject matter can flow to a number of parties. For example, a selling entity 106 in the first country can earn a commission on each sale of a gift card as well as on an in-store reloading of a gift card. A selling entity 106, an entity operating the international gift card service 114, etc. can also pay out consumer referral bonuses in the form of a gift card or additional credit, for example an additional credit redeemable at the selling entity 116, an additional amount of value that a purchaser 102 can convey to a recipient 116 for redemption at a redeeming entity 118 in the second country, etc., to encourage a first purchaser to inform other potential purchasers of the benefits of use of the international gift card service 114 to send a money equivalent without the typically associated fees to a recipient in a second country. The selling entity 106 can also realize other sales from the purchaser 102, who might not otherwise visit the selling entity. Sale of an international gift card consistent with implementations of the current subject matter can, from the perspective of the selling entity 106, be a transaction that is functionally similar to sale of any other gift card. As such, the selling entity 106 can be required to invest very little additional resources (e.g. dedicated headcount, additional shelf space and floor space, etc.) to engage in sales of international gift cards in a manner comparable to those described herein.

A redeeming entity 118 can also receive various benefits. For example, the inflow of money from the purchaser 102 in the first country becomes guaranteed revenue for the redeeming entity 118. The gift cards can be reloadable by additional inflow of value 224 from the purchaser or other purchasers in the first country, which can allow very easy capture of additional guaranteed revenue. If a gift card is lost, deactivated, or otherwise not redeemed, the redeeming entity 118 can receive further benefit by realizing the revenue without being required to provide goods, services, or any other type of value 226 in exchange. Additionally, redemption of gift cards by recipients 116 can bring new consumers into a store, etc. of the redeeming entity 118 instead of into a competitor's store, etc.

FIG. 1 and FIG. 2 illustrate features of a customer experience using implementations of the current subject matter that involve point of sale transactions (e.g. at a physical store location, kiosk, etc.) or transactions confirmed via a computer that accesses a website for both of the purchaser 102 and the recipient 116. Other implementations of the current subject matter can also include features that can enable redemption of a gift card in a rural environment or other location where a point of sale device capable of processing a gift card redemption and communication with the international gift card service 114 over convention computer network approaches is not available. For example, transactions can be verified via SMS, MMS, or IVR and can therefore be handled using existing cell phones and fixed line (PSTN) phones, which are more common in rural areas than are Internet or other network connectivity. The notification module 214 can therefore receive notification of gift card redemption from a variety of potential inputs, such as for example non-email messaging (e.g. SMS, MMS, etc.) 216, an auto-dialer system 220 (e.g. a voice prompted system configured to receive touch tones over a standard phone line in response to voice or other prompts), an IVR system 222, or the like. In other implementations of the current subject matter, a redemption transaction can be verified using a mobile application (e.g. an app for a smart phone or other mobile computing device. In this example, a redeeming entity 118 would require access to a smart phone.

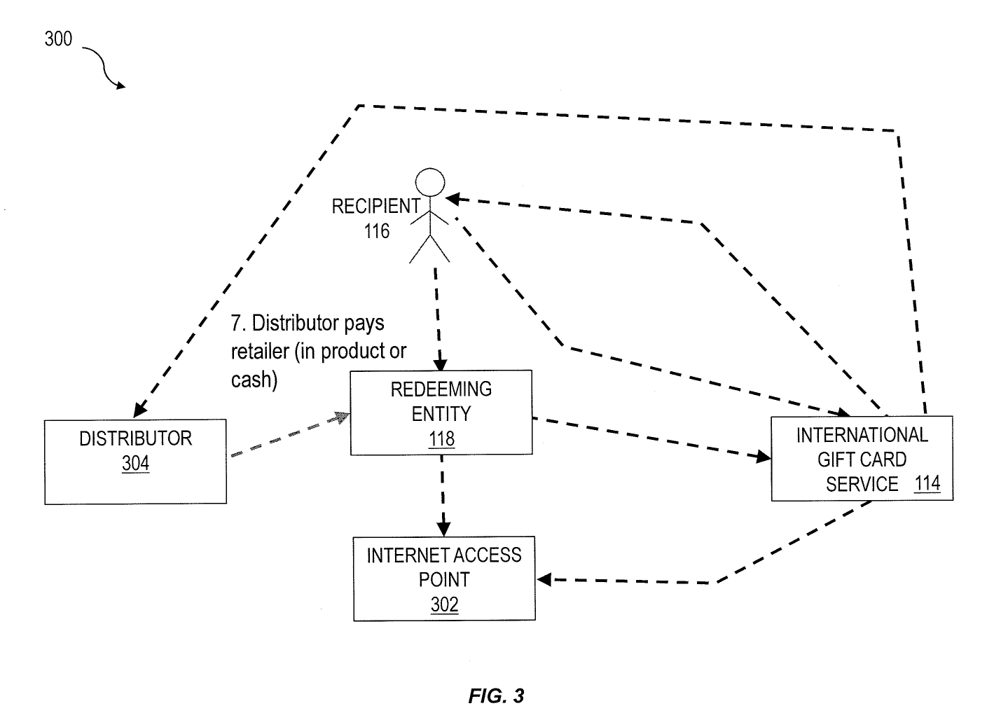

FIG. 3 shows a diagram 300 illustrating a communications flow capable of supporting implementations of the current subject matter in which gift card validations and redemptions are completed using electronic messaging over cellular telephone networks. In the example of FIG. 3, the redeeming entity (e.g. an owner, manager, clerk, etc. at a retailer in the second country) 118 first registers a phone that will be used to process gift card redemptions over SMS, IVR or other non-e-mail messaging. The registering can generally be completed using an Internet access point 302, such as for example at an Internet café. Alternatively or in addition, the registering can also be completed by communicating verbally or in writing with the international gift card service 114 or the like. Upon presentation by a gift card recipient 116 of a redemption code 108 for an international gift card consistent with one or more implementations of the current subject matter, the redeeming entity 118 sends the redemption code 108 for the gift card and the amount of the desired transaction (e.g. how much value of goods, services, etc. the recipient wishes to purchase with the received value or purchasing ability on the gift card) to the international gift card service 114 via SMS, MMS, IVR, or the like.

In another implementation, the registered phone can be used to submit this information verbally over a standard cellular or landline-based telephone voice connection using an IVR system 222 associated with the international gift card service 114. In yet another implementation, an auto-dialer system 220 can give voice or other prompts over a voice connection and can receive the necessary inputs via touchtone input made by the user at the redeeming entity 118. A caller-ID indicating the telephone number from which the user at the redeeming entity makes such a phone call, or alternatively a registration code given to the user at the redeeming entity at the time of registration and then entered via IVR, touchtone response, etc. can be used to verify the identity and authorization of the redeeming entity 118 to conduct a gift card redemption transaction.

Upon receipt by the international gift card service 114 (optionally via a notification module 214 or similar functionality) of the redemption code 108 from the redeeming entity 118, the international gift card service 114 can contact the recipient 116 (optionally via the notification module 214 or similar functionality) using one or more of the above-noted approaches (e.g. SMS, MMS, IVR, autodialer, etc.) to request confirmation of the transaction. The recipient 116 can accept the intended transaction by communicating with the international gift card service 114 (optionally via the notification module 214 or similar functionality) via one or more of the above-noted approaches (e.g. SMS, MMS, IVR, autodialer, etc.). The international gift card service 114 can then contact the redeeming entity 118 (optionally via the notification module 214 or similar functionality) using one or more of the above-noted approaches (e.g. SMS, MMS, IVR, autodialer, etc.) to authorize the transaction, which can then be completed such that the recipient 116 receives from the redeeming entity 118 the desired good, services, redeeming entity-specific gift card, etc. for some or al of the amount available on the international gift card.

The international gift card service 114 can also notify a local distributor 304 of the goods, services, etc. to provide reimbursement to the redeeming entity in the form of cash, goods, etc. This reimbursement, as noted above, is generally for less than the value 226 of the redemption made by the recipient. The reduced reimbursement amount can cover transaction fees paid to one or more of the selling entity 106, the international gift card service 114, currency conversion fees, etc. Alternatively, in some implementations of the current subject matter, the international gift card service 114 can provide direct reimbursement to the redeeming entity 118.

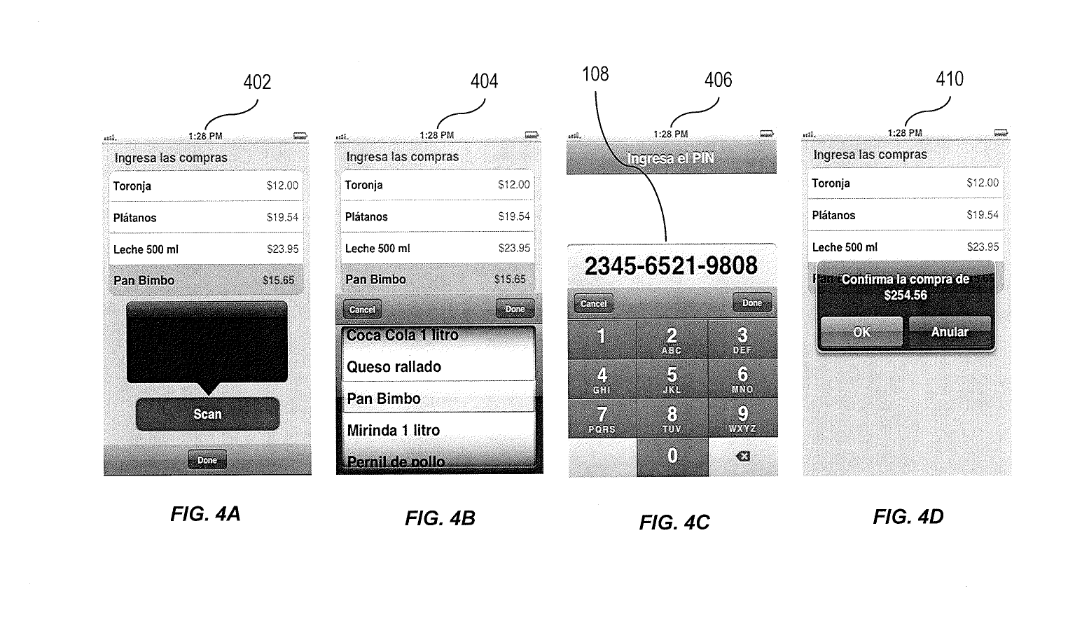

In other implementations of the current subject matter, a redemption transaction can be verified using a mobile application (e.g. an app for a smart phone or other mobile computing device). In this example, a redeeming entity would require access to a smart phone or other portable computing device (e.g. a tablet, a cell phone, a laptop, a desktop computer, a netbook, etc.) capable of performing one or more of the operations discussed herein. FIG. 4A, FIG. 4B, FIG. 4C, and FIG. 4D show four screen shots 402, 404, 406, and 410 of an example mobile application usable via a smart phone to redeem and international gift card consistent with implementations of the current subject matter. In the first screen shot 402, the mobile application can be used to tally the items (e.g. goods, services, etc.) that the recipient 116 wishes to purchase from the redeeming entity 118. The mobile application can optionally integrate with a camera device integrated within or otherwise associated with the smart phone device to scan and recognize bar codes or other optically readable item information to add items to a shopping list that the recipient 116 wishes to purchase. In the screen shot 404 of FIG. 4B, an on-screen menu can be used to add items to the shopping list. In the screen shot 406 of FIG. 4C, the user at the redeeming entity can enter the redemption code 108 for transmission to the international gift card service 114 over a data connection. The screen shot 410 shows a confirmation screen that can be displayed prior to submitting the total amount of value to be redeemed and the redemption code 108 to the international gift card service 114. In some implementations, the mobile application can then request entry of a confirmation code or other information by the recipient 116 to verify the desire to complete the transaction.

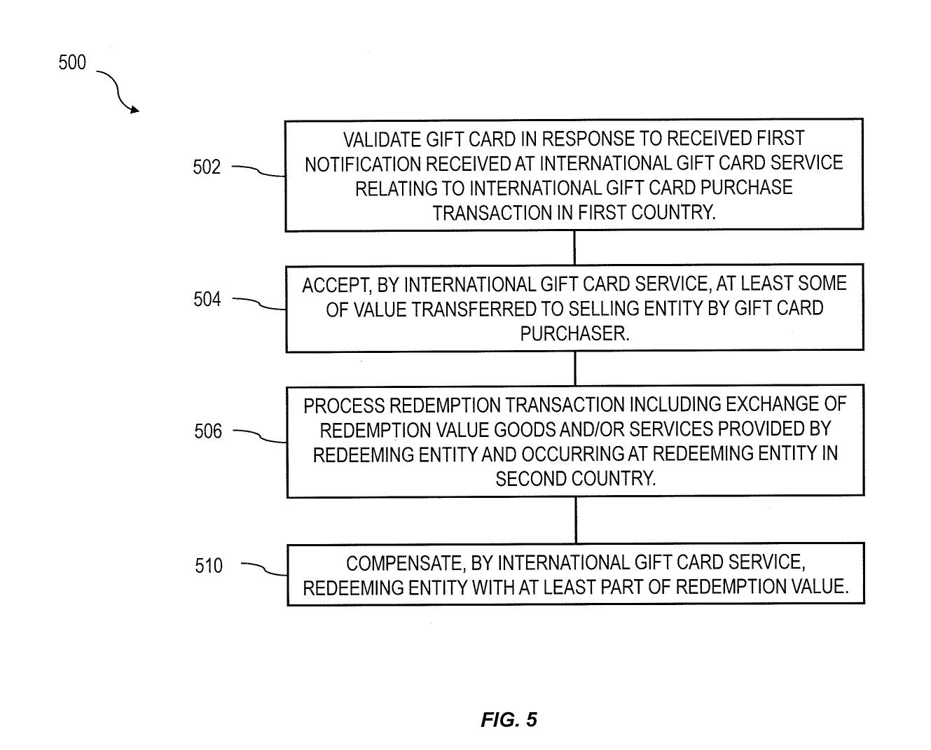

FIG. 5 shows a process flow chart 500 illustrating features of a method. One or more of these features may be present in various implementations of the current subject matter. At 502, an international gift card service, which as noted above can be implemented on one or more systems including one or more programmable processors, validates a gift card in response to a first notification received at the international gift card service from a selling entity doing business in a first country. The notification can relate to an international gift card purchase transaction between a purchaser and the selling entity. The purchase transaction includes a transfer of value from the purchaser to the selling entity in exchange for a gift card credit amount. The purchase transaction can include a purchase of a new gift card, an “add value” transaction using a previously purchased gift card, or the like. The international gift card purchase transaction can occur via a first physical retail location, a first dedicated public kiosk, a first online transaction, or the like, including any other variations described herein and those with functionality similar or equivalent to such variations. The gift card can be a physical gift card or a virtual gift card. The transfer of value can include a cash or cash equivalent payment, a credit card purchase transaction, an exchange of some other item of value between the purchaser and the selling entity, etc. The international gift card purchase transaction transfer of value can include or otherwise by exchanged between the gift card purchaser and the selling entity in a first currency of the first country.

At 504, the international gift card service accepts from the selling entity all or at least some of the value transferred to the selling entity by the purchaser. For example, in some examples, the entirety of the value can be transferred to the international gift card service. In other examples, the selling entity can retain part of the amount of value as a transaction fee to thereby incentivize the selling entity to sell international gift cards on behalf of the international gift card service.

At 506, the international gift card service processes a redemption transaction occurring at a redeeming entity in a second country. The redemption transaction can include an exchange of a redemption value in exchange for one or more goods and services provided by the redeeming entity. The redemption value includes at least some of the gift card amount. The processing can optionally include one or more of a fraud detection process, a validation process, a verification process, or the like to determine that a redemption code used by the recipient in the redemption is correct, valid, etc. and that the gift card corresponding to the redemption code includes a sufficient value to cover the redemption value. The redemption value of the redemption transaction can include or otherwise be exchanged between the redeeming entity and a recipient of the gift card a second currency of the second country. The redemption transaction can occur via a second physical retail location, a second dedicated public kiosk, a second online transaction, or the like.

At 510, the international gift card service compensates the redeeming entity with at least a part of the redemption value, optionally by providing one or more of currency, goods, credits, etc. to the redeeming entity. The provided compensation can optionally be equal to the redemption value less at least one of a currency conversion fee, a transaction fee retained by the international gift card service, etc.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
validating, by an international gift card service implemented on at least one programmable processor, a gift card in response to a first notification received at the international gift card service from a selling entity doing business in a first country, the notification relating to an international gift card purchase transaction comprising a transfer of value from a purchaser to the selling entity in exchange for a gift card credit amount;
accepting, by the international gift card service from the selling entity, at least some of the value transferred to the selling entity by the purchaser;
processing, by the international gift card service, a redemption transaction occurring at a redeeming entity in a second country, the redemption transaction comprising an exchange of a redemption value for one or more goods and services provided by the redeeming entity, the redemption value comprising at least some of the gift card credit amount; and
compensating, by the international gift card service, the redeeming entity with at least a part of the redemption value.

2. A method as in claim 1, wherein the transfer of value comprises at least one of a cash or cash equivalent payment, a credit card purchase transaction, and an exchange of an item of value between the purchaser and the selling entity.

3. A method as in claim 1, wherein the international gift card purchase transaction comprises at least one of a purchase of a new gift card and an add value transaction using a previously purchased gift card.

4. A method as in claim 1, wherein the international gift card purchase transaction occurs via at least one of a first physical retail location, a first dedicated public kiosk, and a first online transaction, and wherein the redemption transaction occurs via at least one of a second physical retail location, a second dedicated public kiosk, and a second online transaction.

5. A method as in claim 1, wherein the processing comprises determining that a redemption code provided to the recipient by the purchaser and redeemed at the redeeming entity is correct and valid and that the gift card currently includes a sufficient value to cover the redemption value.

6. A method as in claim 1, wherein the compensating comprises the international gift card service compensating the redeeming entity with the redemption value less at least one a currency conversion fee, a transaction fee retained by the international gift card service.

7. A method as in claim 1, wherein the international gift card purchase transaction transfer of value comprises a first currency of the first country and the redemption value of the redemption transaction comprises a second currency of the second country.

8. A computer program product comprising a machine-readable medium storing instructions that, when executed by at least one programmable processor, cause the at least one programmable processor to perform operations of an international gift card service, the operations comprising:
validating a gift card in response to a first notification received at the international gift card service from a selling entity doing business in a first country, the notification relating to an international gift card purchase transaction comprising a transfer of value from a purchaser to the selling entity in exchange for a gift card credit amount;
accepting at least some of the value transferred to the selling entity by the purchaser;
processing a redemption transaction occurring at a redeeming entity in a second country, the redemption transaction comprising an exchange of a redemption value for one or more goods and services provided by the redeeming entity, the redemption value comprising at least some of the gift card credit amount; and
compensating the redeeming entity with at least a part of the redemption value.

9. A computer program product as in claim 8, wherein the transfer of value comprises at least one of a cash or cash equivalent payment, a credit card purchase transaction, and an exchange of an item of value between the purchaser and the selling entity.

10. A computer program product as in claim 8, wherein the international gift card purchase transaction comprises at least one of a purchase of a new gift card and an add value transaction using a previously purchased gift card.

11. A computer program product as in claim 8, wherein the international gift card purchase transaction occurs via at least one of a first physical retail location, a first dedicated public kiosk, and a first online transaction, and wherein the redemption transaction occurs via at least one of a second physical retail location, a second dedicated public kiosk, and a second online transaction.

12. A computer program product as in claim 8, wherein the processing comprises determining that a redemption code provided to the recipient by the purchaser and redeemed at the redeeming entity is correct and valid and that the gift card currently includes a sufficient value to cover the redemption value.

13. A computer program product as in claim 8, wherein the compensating comprises the international gift card service compensating the redeeming entity with the redemption value less at least one a currency conversion fee, a transaction fee retained by the international gift card service.

14. A computer program product as in claim 8, wherein the international gift card purchase transaction transfer of value comprises a first currency of the first country and the redemption value of the redemption transaction comprises a second currency of the second country.

15. A system comprising:
at least one programmable processor; and
a machine-readable medium storing instructions that, when executed by the at least one processor, cause the at least one programmable processor to perform operations of an international gift card service, the operations comprising:
validating a gift card in response to a first notification received at the international gift card service from a selling entity doing business in a first country, the notification relating to an international gift card purchase transaction comprising a transfer of value from a purchaser to the selling entity in exchange for a gift card credit amount;
accepting at least some of the value transferred to the selling entity by the purchaser;
processing a redemption transaction occurring at a redeeming entity in a second country, the redemption transaction comprising an exchange of a redemption value for one or more goods and services provided by the redeeming entity, the redemption value comprising at least some of the gift card credit amount; and
compensating the redeeming entity with at least a part of the redemption value.

16. A system as in claim 15, wherein the transfer of value comprises at least one of a cash or cash equivalent payment, a credit card purchase transaction, and an exchange of an item of value between the purchaser and the selling entity.

17. A system as in claim 15, wherein the international gift card purchase transaction comprises at least one of a purchase of a new gift card and an add value transaction using a previously purchased gift card.

18. A system as in claim 15, wherein the international gift card purchase transaction occurs via at least one of a first physical retail location, a first dedicated public kiosk, and a first online transaction, and wherein the redemption transaction occurs via at least one of a second physical retail location, a second dedicated public kiosk, and a second online transaction.

19. A system as in claim 15, wherein the processing comprises determining that a redemption code provided to the recipient by the purchaser and redeemed at the redeeming entity is correct and valid and that the gift card currently includes a sufficient value to cover the redemption value.

20. A system as in claim 15, wherein the international gift card purchase transaction transfer of value comprises a first currency of the first country and the redemption value of the redemption transaction comprises a second currency of the second country.
